(19) United States
(12) Patent Application Publication
(10) Pub. No.: US 2007/0118058 A1
(43) Pub. Date: May 24, 2007

(54) Waterproofing structure

(75) Inventor: Toshio Isshiki, Tokyo (JP)

Correspondence Address: BURR & BROWN, PO BOX 7068, SYRACUSE, NY, 13261-7068, US

(73) Assignee: Isshiki Co., Ltd., Bunkyo-Ku (JP)

(21) Appl. No.: 11/326,087

(22) Filed: Jan. 5, 2006

(30) Foreign Application Priority Data
Nov. 21, 2005 (JP) 2005-336390

(51) Int. Cl. A61H 1/00

(52) U.S. Cl. 601/70; 601/46; 601/80

(57) ABSTRACT

A waterproofing structure for protecting a drive device in a water-tight state which includes a power supply unit cover formed to have an opening at its one end and to cover a power supply unit of the drive device in a water-tight state, and a drive unit cover formed to have an opening at its one end and to cover a drive unit of the drive device in a water-tight state.

### BACKGROUND OF THE INVENTION

The present invention relates to a waterproofing structure for a drive device, which can be used in a bathroom or a water using area, and more particularly to a waterproofing structure which can protect the engaging portion of the drive unit in a water-tight state and which can establish the water-tight state without raising the cost.

In the prior art, the drive device of an electric toy or a massage device to be used in the bathroom, outdoors or under the environment to be exposed to a liquid is composed of electronic devices such as a battery box, a motor or a controller switch. In order to prevent the drive device from being troubled by the water, there exists a waterproofed apparatus which is closely covered with a waterproof cover

In JP-A-2005-237911, the vibrator is covered with a bag-shaped member made of an extensible waterproof material so that the vibrator can be protected in the water-tight state and used in the water using area. However, the vibrator has its opening covered with an opening having a close contacting diameter. In the using situations, the opening of the bag-shaped member may be curled up against the contacting force of the opening. This raises a problem that water droplets may penetrate through the curled-up portion into the vibrator.

In JP-B-06-17516, the open end portion of a waterproof cover is curled up and fitted in the two streaks of grooves formed in the outer side face of the battery box so that it can cover the battery box thereby to prevent the water leakage. In this battery box according to the device, the engagement between the two streaks of grooves and the curled open end portion may be released in the using situations, thereby to curl up the waterproof cover against the contacting force of the open end portion. As a result, there arises a problem that the water droplets may penetrate into the battery box from the curled-up portion.

If the battery case or the control button unit is formed of the waterproofing structure without using the aforementioned cover, the construction is complicated, and the waterproof portion has to be precisely formed. This raises a problem that manufacturing thereof is troublesome to raise the manufacturing cost.

Therefore, an object of the invention is to provide a waterproofing structure which can protect the drive device in the water-tight state and which can establish the water-tight state without raising the cost.

### SUMMARY OF THE INVENTION

In order to solve those technical problems, according to the invention, there is provided a waterproofing structure for a drive device including: a power supply unit; and a drive unit formed to protrude from one end of the power supply unit and to be activated with an electric power supplied from the power supply unit. The waterproofing structure comprises: a power supply unit cover formed to have an opening at its one end and to cover the power supply unit in the water-tight state; and a drive unit cover formed to have an opening at its one end and to cover the drive unit in the water-tight state. The power supply unit includes at its one end: a supporting cylinder unit formed to protrude to the side of the drive unit; and a protecting cylinder unit formed outside of the diameter of and at a predetermined spacing size from the supporting cylinder unit. The drive unit cover has its opening edge portion fitted in the water-tight state between the supporting cylinder unit and the protecting cylinder unit so that the opening circumferential edge portion of the drive unit cover and the protecting cylinder unit in the water-tight state with the opening edge portion of the power supply unit cover.

According to the waterproofing structure of the invention, therefore, the opening edge portion of the drive unit cover is fitted between the supporting cylinder unit and the protecting cylinder unit so that the drive unit can be protected in the water-tight state.

Also, the opening edge portion of the drive unit cover and the supporting cylinder unit can be protected in the water-tight state by covering them with the power supply unit cover.

By the drive unit cover and the power supply unit cover, therefore, the drive device can be protected in the water-tight state.

In the invention, the opening edge portion of the drive unit cover has a ridge portion formed along the outside of the side edge of the opening edge portion for holding the water-tight state inside of the drive unit cover when press-fitted between the supporting cylinder unit and the protecting cylinder unit.

By the ridge portion, therefore, the drive unit cover can be held in the water-tight state.

In the invention, the drive unit cover is made of a waterproof material having an extensibility and has an internal diameter size substantially equal to the external diameter size of the supporting cylinder unit, and the ridge portion has an external diameter size substantially equal to the internal diameter size of the protecting cylinder unit.

Since the drive unit cover is made of the waterproof material, the drive unit can be protected in the water-tight state.

Since the internal diameter size of the drive unit cover is made substantially equal to the external diameter size of the supporting cylinder unit, the ridge portion is press-fitted between the supporting cylinder unit and the protecting cylinder unit so that the supporting cylinder unit can be fixed in close contact with the drive unit cover thereby to hold the water-tight state in the drive unit arranged in the drive unit cover.

In the invention, the power supply unit cover is made of a waterproof material having an extensibility and has an internal diameter size slightly larger than the external diameter size of the power supply unit, and the opening edge portion of the power supply unit cover has an engaging ridge portion formed smaller than the internal diameter size of the protecting cylinder unit.

As a result, the power supply unit can be covered with the power supply unit cover, and the ridge portion of the drive unit cover is enabled by the engaging ridge unit to cover the protecting cylinder unit, which is press-fitted between itself and the supporting cylinder unit, in a more water-tight state from the outside.

In the invention, the power supply unit cover is made of a soft material and disposed at the power supply unit for operating a switch unit disposed to control the drive unit.

As a result, the switch unit can be operated from the outside even in the case the power supply unit is covered with the power supply unit cover.

In the invention, the power supply unit is formed of a battery box, and the power supply unit cover can be removed, if necessary. As a result, the power supply unit can be removed for use, if necessary.

In the invention, the drive unit includes a prime mover, and a vibrator formed to vibrate in association with the prime mover, and the switch unit is configured with push buttons.

As a result, the drive unit can be operated by pushing the push button.

In the invention, the switch unit is configured with a dial. As a result, the drive unit can be operated by turning the dial.

In the invention, the switch unit is configured with a slider. As a result, the drive unit can be operated by sliding the slider.

In the waterproofing structure of the invention, the drive device can be protected in the water-tight state by the drive unit cover and the power supply unit cover thereby to protect the battery box composing the drive device, and the electronic device such as the motor or the controller switch against the humidity.

Moreover, the opening edge portion of the drive unit cover is fitted between the supporting cylinder unit and the protecting cylinder unit so that the penetration of water droplets, as might otherwise be caused by the curling-up of the end edge of the opening edge portion of the drive unit cover, can be prevented while holding the water-tight state of the drive unit thereby to ensure the water-tight state of the drive unit.

Moreover, while the opening edge portion of the drive unit cover being fitted between the supporting cylinder unit and the protecting cylinder unit, the opening edge portion of the power supply unit cover can cover the opening edge portion of the drive unit cover and the protecting cylinder unit formed to protrude radially outward of the supporting cylinder unit. It is, therefore, possible to ensure the water-tight state of the drive unit cover and to prevent the power supply unit cover from coming out of the power supply unit.

Since the protecting cylinder unit can be covered with the opening edge portion of the power supply unit cover, the power supply unit cover is not easily curled up so that the liquid can be prevented from penetrating into the power supply unit.

As a result, the drive unit and the power supply unit themselves need not be constructed of the waterproofing structure so that they can be protected in the water-tight state without raising the manufacturing cost.

In the waterproofing structure of the invention, the opening edge portion of the drive unit cover has a ridge portion formed along the outside of the side edge of the opening edge portion for holding the in the water-tight state state inside of the drive unit cover when press-fitted between the supporting cylinder unit and the protecting cylinder unit. As a result, the ridge portion is press-fitted between the supporting cylinder unit and the protecting cylinder unit so that the liquid can be prevented from flowing into the drive unit inside of the drive unit cover.

As a result, the drive unit can be protected against the humidity so that the drive device can be safely used even under the humid environment such as in the bathroom or in the water using area.

In the waterproofing structure of the invention, the drive unit cover is made of the extensible waterproof material. Even in the case, therefore, the drive unit is activated, the drive unit cover is extended/shrunken according to the vibrations or rotations of the drive unit to cover and protect the drive unit in the water-tight state.

Moreover, the drive unit cover can be extended/shrunken according to the shape of the drive unit thereby to cover the drive unit. Therefore, drive unit cover can cover the drive unit, even if this drive unit is more or less corrugated, thereby to protect the drive unit in the water-tight state.

The internal diameter size of the drive unit cover is made substantially equal to the external diameter size of the supporting cylinder unit, and the external diameter size of the ridge portion is made substantially identical to the internal diameter size of the protecting cylinder unit. By fitting the drive unit cover on the supporting cylinder unit, therefore, the drive unit cover can extend to come into close contact with the outer side face of the supporting cylinder unit, and the ridge portion also comes into close contact with the inner side face of the protecting cylinder unit. By the ridge portion, therefore, the supporting cylinder unit and the protecting cylinder unit can be hermetically closed to prevent the penetration of the liquid into the drive unit cover thereby to protect the drive unit reliably in the water-tight state.

Even in the case, therefore, the drive device is used under humid environment such as in the bathroom or in the water using area, the drive device can be protected against the humidity.

In the waterproofing structure of the invention, the power supply unit cover is made of the extensible waterproof material. Therefore, the power supply unit cover can come into close contact with the power supply unit, when used, to protect it in the water-tight state, and is extended, if necessary, to remove the power supply unit cover from the power supply unit.

By extending the power supply unit cover in accordance with the shape of the power supply unit, moreover, the power supply unit can be covered and protected in the water-tight state, even if its shape has more or less corrugations.

Moreover, the internal diameter size of the power supply unit cover is made slightly larger than the external diameter size of the power supply unit. Even in the case, therefore, the power supply unit is corrugated, it can be covered and protected in the water-tight state no matter what external shape it might have.

On the opening edge portion of the power supply unit cover, moreover, the engaging ridge portion is formed to have an internal diameter size than that of the internal diameter size of the protecting cylinder unit. While the power supply unit being covered with the power supply unit cover, the engaging ridge portion can be held in abutment against the outer side face of the drive unit cover thereby to hold the water-tight state more reliably between the opening edge portion and the drive unit cover.

As a result, the power supply unit can be covered with the power supply unit cover, and the engaging ridge portion can cover the protecting cylinder unit, which is press-fitted between itself and the supporting cylinder unit, in a more water-tight state from the outside, thereby to prevent a liquid such as water from flowing into the power supply unit.

In the waterproofing structure of the invention, the power supply unit cover is made of the soft material, so that the switch unit formed at the power supply unit can be operated from the outside of the power supply unit cover.

By operating the switch unit while keeping the water-tight state at the power supply unit, therefore, it is possible to provide the waterproofing structure for the drive device, which can operate the drive unit.

In the waterproofing structure of the invention, the battery housed in the battery box can be easily extracted and exchanged by extracting the power supply unit cover from the battery box.

If necessary, moreover, the waterproofing structure can be used in the water-tight state by mounting the power supply unit cover on the power supply unit.

In the waterproofing structure of the invention, the switch unit has push buttons. While the power supply unit is being protected in the water-tight state, the drive unit can be controlled by pushing the push buttons.

As a result, the push buttons can be protected in the water-tight state without making their own structure water-tight. Therefore, the drive device can be protected in the water-tight state as a whole without raising the manufacturing cost.

In the waterproofing structure of the invention, the switch unit has a dial. While the power supply unit is being protected in the water-tight state, the drive unit can be controlled by turning the dial.

As a result, the dial can be protected in the water-tight state without making its own structure water-tight. Therefore, the drive device can be protected in the water-tight state as a whole without raising the manufacturing cost.

In the waterproofing structure of the invention, the switch unit has a slider. While the power supply unit is being protected in the water-tight state, the drive unit can be controlled by sliding the slider.

As a result, the dial can be protected in the water-tight state without making its own structure water-tight. Therefore, the drive device can be protected in the water-tight state as a whole without raising the manufacturing cost.

A waterproofing structure according to the invention is described in detail in connection with its embodiment shown in the accompanying drawings.

### BRIEF DESCRIPTION OF THE DRAWINGS

FIG. 1 is a perspective view showing the entirety of an embodiment, in which the waterproofing structure according to the invention is employed in the drive device.

FIG. 2 is a perspective view showing the drive unit cover of the waterproofing structure according to the invention.

FIG. 3 is a perspective view showing the power supply unit cover of the waterproofing structure according to the invention.

FIG. 4 is a perspective view showing a power supply unit, a supporting cylinder unit and a protecting cylinder unit to be used in the waterproofing structure according to the invention.

FIG. 5 is a perspective view showing a drive unit, the supporting cylinder unit and the protecting cylinder unit to be used in the waterproofing structure according to the invention.

FIG. 6 is a perspective view showing the power supply unit, the supporting cylinder unit and the protecting cylinder unit to be used in the waterproofing structure according to the invention.

FIG. 7 is a longitudinal section taken along line Y-Y′ of FIG. 1 according to the invention.

### DESCRIPTION OF THE PREFERRED EMBODIMENT

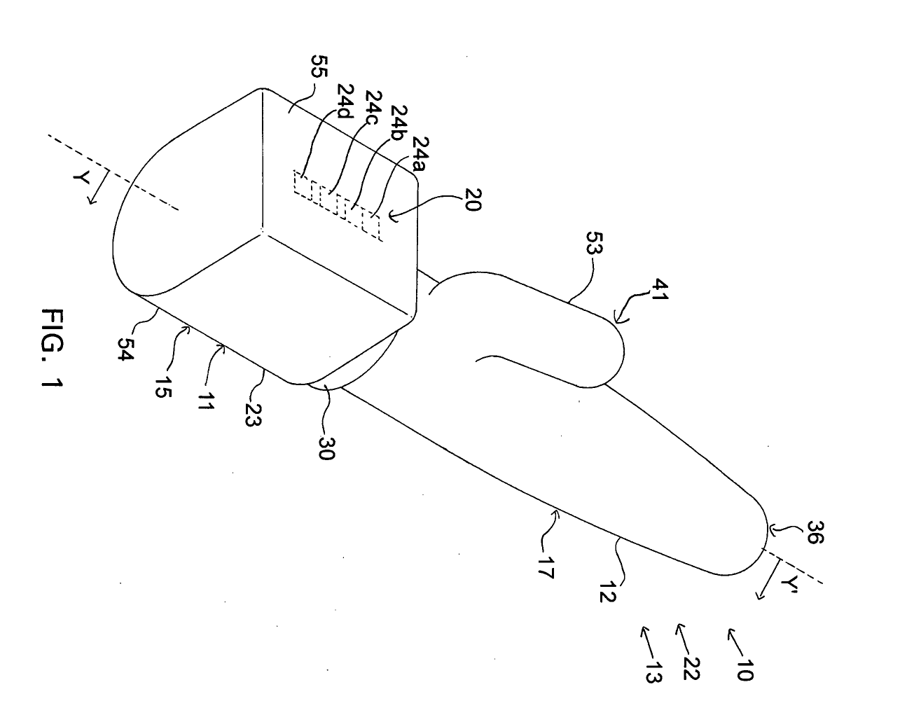

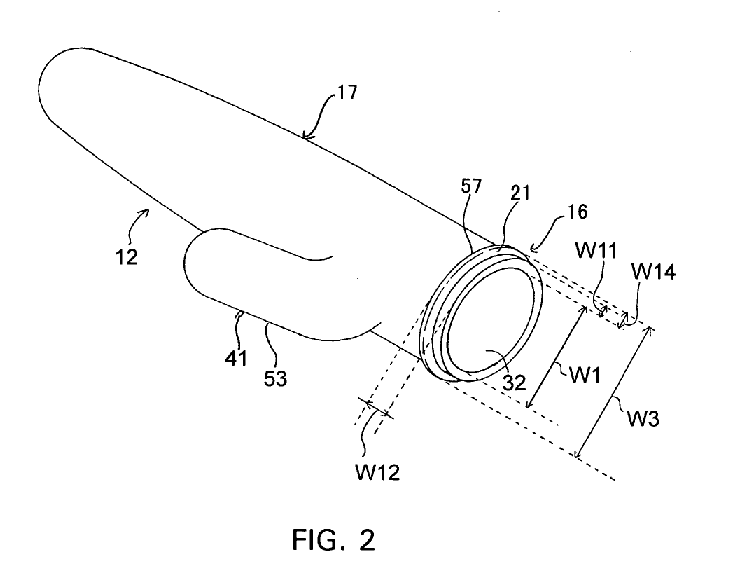

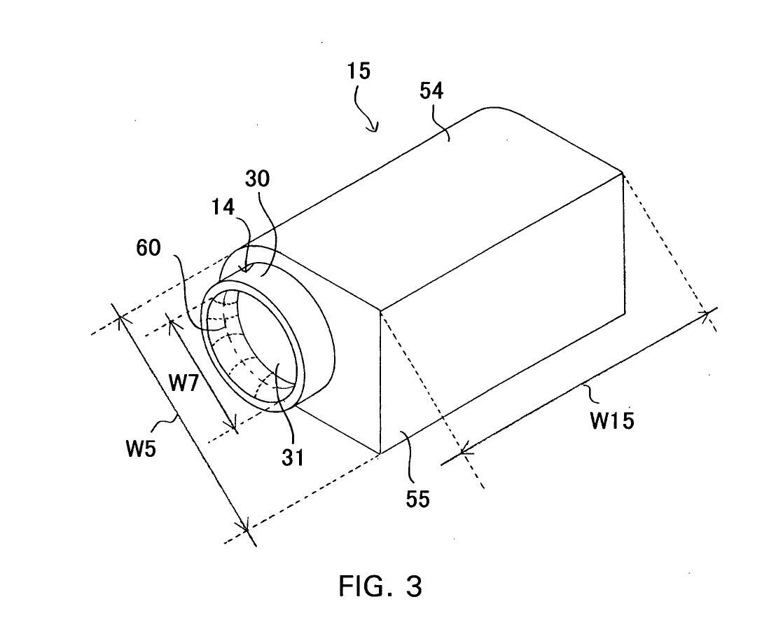

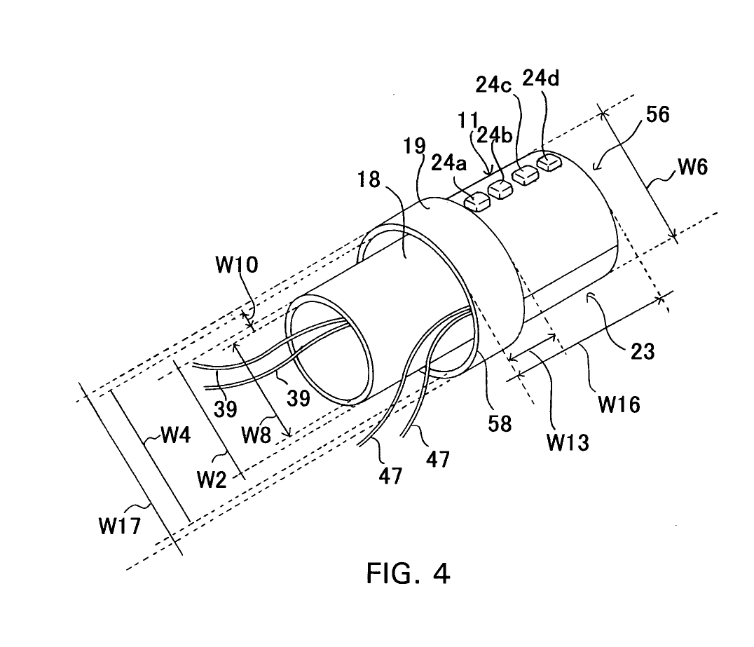

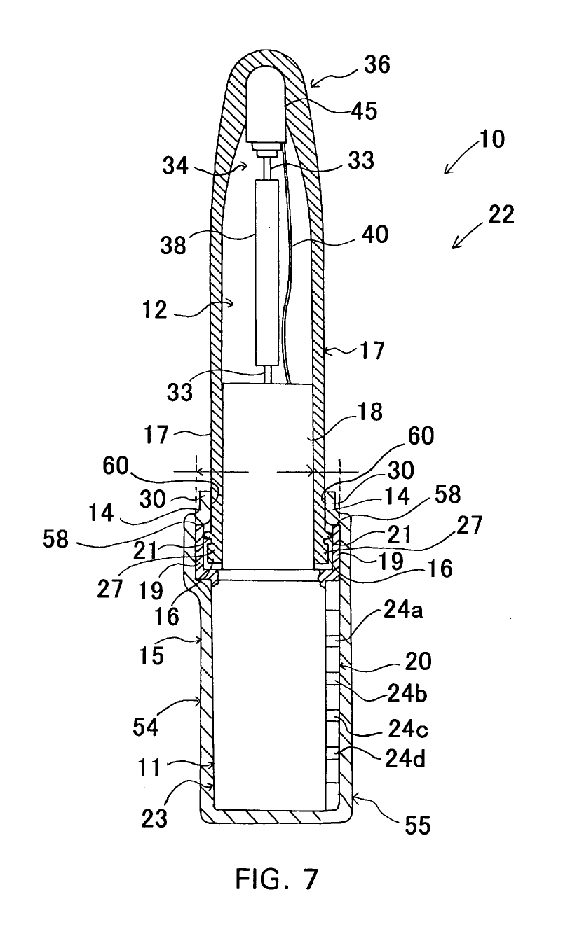

As shown in FIG. 1, the waterproofing structure 10 according to this embodiment is of a drive device 13, which is constructed to include a power supply unit 11 and a drive unit 12 formed to protrude from one end of the power supply unit 11 and to be driven by an electric power supplied from the power supply unit 11. The waterproofing structure 10 includes a power supply unit cover 15 formed to have an opening 31 at its one end and to cover the power supply unit 11 in the water-tight state, as shown in FIG. 1 and FIG. 3, and a drive unit cover 17 formed to have an opening 32 at its one end and to cover the drive unit 12 in the water-tight state, as shown in FIG. 1 and FIG. 2. As shown in FIG. 4, the power supply unit 11 is provided at its one end with a supporting cylinder unit 18 formed to protrude to the side of the drive unit 12, and a protecting cylinder unit 19 formed radially outside of and at a predetermined spacing from the supporting cylinder unit 18. As shown in FIG. 7, an opening edge portion 16 of the drive unit cover 17 is fitted in the water-tight state between the supporting cylinder unit 18 and the protecting cylinder unit 19, and an opening circumferential edge portion 27 and the protecting cylinder unit 19 are covered in the water-tight state by an opening edge portion 14 of the power supply unit cover 15.

As shown in FIG. 2, moreover, the opening edge portion 16 of the drive unit cover 17 is provided with a ridge portion 21, which is so formed along the side edge outside of the opening edge portion 16 as to hold the water-tight state inside of the drive unit cover 17, as shown in FIG. 7, when press-fitted between the supporting cylinder unit 18 and the protecting cylinder unit 19.

As shown in FIG. 2 and FIG. 4, the drive unit cover 17 is made of a waterproof material having an extensibility. An internal diameter size W1 is made substantially equal to the external diameter size W2 of the supporting cylinder unit 18, and an external diameter size W3 of the ridge portion 21 is made substantially equal to the internal diameter size W4 of the protecting cylinder unit 19.

As shown in FIG. 3 and FIG. 4, the power supply unit cover 15 is made of an extensible waterproof material. An internal diameter size W5 is made slightly larger than the external diameter size W6 of the power supply unit 11. The opening edge portion 14 of the power supply unit cover 15 is provided with an engaging ridge portion 30 having an internal diameter size W7 smaller than the internal diameter size W4 of the protecting cylinder unit 19.

As shown in FIG. 1 and FIG. 3, moreover, the power supply unit cover 15 is made of a soft material, and is formed to operate from the outside a switch unit 20 for controlling the drive unit 12.

As shown in FIG. 1 and FIG. 6, the power supply unit 11 is formed of a battery box 23, and the power supply unit cover 15 is removably formed.

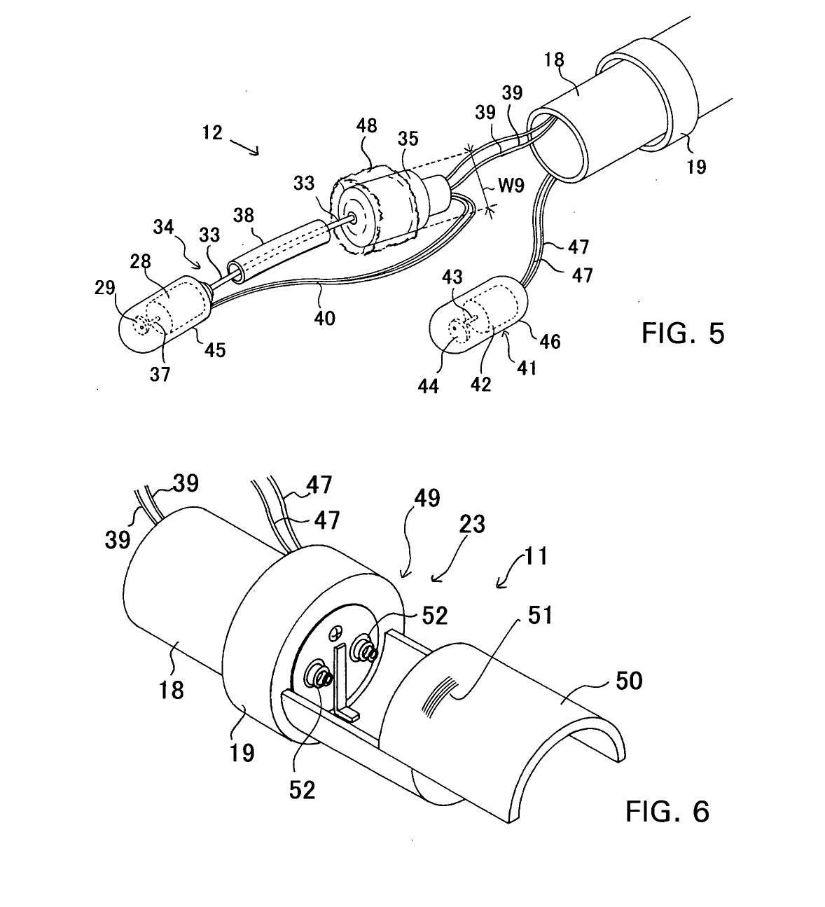

As shown in FIG. 1 and FIG. 5, the drive unit 12 is formed to include a prime mover unit 28, and a vibrator 29 for vibrating in association with the prime mover unit 28. The switch unit 20 is composed of push buttons 24a, 24b, 24c and 24d.

Moreover, the switch unit 20 is formed of a dial. Alternatively, the switch unit 20 is formed of a slider.

FIG. 1 shows the waterproofing structure 10 according to the embodiment of the invention. The waterproofing structure 10 according to this embodiment is provided for the drive device 13 to be used in a bathroom or water facilities. Specifically, the waterproofing structure 10 is of the drive device 13 including a vibrator 22 provided with the power supply unit 11 including the battery box 23 and a vibrating unit 36 which is formed so as to vibrate by the electric power supplied from the battery box 23.

As shown in FIG. 5, the vibrating unit 36 is provided with the prime mover unit 28, and the vibrator 29 for vibrating in association with the prime mover unit 28.

As shown in FIG. 1 and FIG. 3, the waterproofing structure 10 is constructed to include the power supply unit cover 15, which is formed to have the opening 31 at its one end and to cover the power supply unit 11 in the water-tight state, as shown in FIG. 1 and FIG. 2, and the drive unit cover 17 formed to have the opening 32 at its one end and to cover the drive unit 12 in the water-tight state.

As shown in FIG. 4, the power supply unit 11 is provided at its one end with the supporting cylinder unit 18 formed to protrude to the side of the drive unit 12, and the protecting cylinder unit 19 formed radially outside of and at a predetermined spacing from the supporting cylinder unit 18.

As shown in FIG. 7, the opening edge portion 16 of the drive unit cover 17 is fitted between the supporting cylinder unit 18 and the protecting cylinder unit 19 thereby to retain the water-tight state between the drive unit cover 17 and the supporting cylinder unit 18.

As shown in FIG. 5, the drive unit 12 is constructed to include a rotating motor 35, a shaft 33 disposed to extend from the drive shaft of the rotating motor 35, and the vibrating unit 36 disposed at the leading end portion 34 of the shaft 33.

As shown in FIG. 5, the shaft 33 is curved so that the vibrating unit 36 disposed at the leading end portion 34 of the shaft 33 can be caused to make eccentric motions by the rotating motions of the rotating motor 35.

On the outer side of the shaft 33, there is disposed a cylindrical protecting tube 38, which is extended along the length direction of the shaft 33. In the case the drive unit 12 is housed in the drive unit cover 17, the protecting tube 38 is enabled to prevent the inner side face of the drive unit cover 17 from being fretted by the rotating motions of the shaft 33.

Moreover, the shaft 33 does not come into direct abutment against the inner side face of the drive unit cover 17 so that the shaft 33 can make rotating motions without being obstructed.

The vibrating unit 36 is provided with the prime mover unit 28 adapted to be rotated by the electric power from the power supply unit 11, and the vibrator 29 adapted to vibrate integrally with the prime mover unit 28 by the rotating motions of the prime mover unit 28. The vibrating unit 36 is housed in a capsule 45 formed generally into an elliptical shape.

The vibrator 29 is formed into a disc shape and comes, when it takes a position eccentric from the center of the disc, into engagement with the drive shaft 37 of the prime mover unit 28, so that the vibrator 29 can be vibrated by the rotating motions of the prime mover unit 28 thereby to vibrate the vibrating unit 36 as a whole.

As shown in FIG. 5, conductors 39 for supplying the electric power of the power supply unit are connected with the rotating motor 35, and conductors 40 for supplying the electric power of the power supply unit 11 are connected with the prime mover unit 28.

As shown in FIG. 4, the supporting cylinder unit 18 has an internal diameter size W8 made larger than the external diameter size W9 of the rotating motor 35, as shown in FIG. 5, so that the rotating motor 35 can be housed in the supporting cylinder unit 18.

On the peripheral edge portion of the rotating motor 35, there is disposed a sponge 48, which extends along the outer circumference of the rotating motor 35 so that it can fill the clearance between the rotating motor 35 and the supporting cylinder unit 18, when the rotating motor 35 is housed in the supporting cylinder unit 18, thereby to fix the rotating motor 35 in the supporting cylinder unit 18.

On the side face on the opposite side of a cover portion 50 disposed at the battery box 23, as shown in FIG. 4, there is disposed the switch unit 20 for controlling the prime mover unit 28, an auxiliary prime mover unit 42 and the rotating motor 35, which are disposed in the drive unit 12. The switch unit 20 is composed of push buttons 24a, 24b, 24c and 24d.

As shown in FIG. 4, the four push buttons 24a, 24b, 24c and 24d are disposed along the length direction of the battery box 23. The push button 24a functions as a starting switch of the prime mover unit 28 and the rotating motor 35. The push button 24b functions as a switch for changing the rotating speeds of the prime mover unit 28 and the rotating motor 35. The push button 24c functions as a starting switch of the auxiliary prime mover unit 42. The push button 24d functions as a switch for changing the rotating speed of the auxiliary prime mover unit 42.

As shown in FIG. 1, an auxiliary vibrating unit 41 is formed to protrude obliquely from the supporting cylinder unit driving unit.

The auxiliary vibrating unit 41 is provided, like the vibrating unit 36, with the auxiliary prime mover unit 42 formed to be rotated by the electric power from the power supply unit 11, and a vibrator 44 disposed on a drive shaft 43 of the auxiliary prime mover unit 42 to vibrate integrally with the auxiliary prime mover unit 42. The auxiliary vibrating unit 41 is housed in an auxiliary capsule 46, which is generally formed into an elliptical shape.

As shown in FIG. 5, the vibrator 44 is formed into a disc shape and comes, when it takes a position eccentric from the center of the disc, into engagement with the drive shaft 43 of the auxiliary prime mover unit 42, so that the vibrator 44 can be vibrated by the rotating motions of the auxiliary mover unit 42 thereby to vibrate the auxiliary vibrating unit 41 as a whole.

As shown in FIG. 5, the auxiliary vibrating unit 41 is covered with and protected by the auxiliary capsule 46 having the generally elliptical shape. Conductors 47 for supplying the electric power of the power supply unit 11 are connected with the auxiliary mover unit 42.

As shown in FIG. 6, the power supply unit 11 is provided with the battery box 23 formed into a generally cylindrical shape on the side of the trailing end 56 of the drive device 13. The battery box 23 is provided with a battery case 49 and the cover portion 50 formed to hold the battery arranged in the battery case 49.

The cover portion 50 is formed to have an arcuate transverse section and can be removably fitted on the battery box 23 by sliding it in the length direction of the battery box 23.

As shown in FIG. 6, the cover portion 50 is provided on its outer side face with a non-slip portion 51, which is formed of a plurality grooves cut along the widthwise direction of the battery box 23.

With a finger attached to the non-slip portion 51 to slide the cover portion 50, if necessary, the battery case 49 can be opened outward to permit the battery housed in the battery box 23 to be taken out.

As shown in FIG. 6, the battery case 49 is provided with battery holding springs 52 for holding the battery in the battery case 49 so that the electric power supplied from the battery can be supplied to the drive unit 12.

As shown in FIG. 4, the supporting cylinder unit 18 is formed into the cylindrical shape to thread the conductors for supplying the electric power from the battery box 23 to the drive unit 12.

As a result, the electric power of the battery box 23 can be supplied to the drive unit 12 in the state where the power supply unit 11 is covered with the power supply unit cover 15 and where the drive unit 12 is covered in the water-tight state with and protected by the drive unit cover 17, as shown in FIG. 1.

As shown in FIG. 4, the spacing size W10 between the supporting cylinder unit 18 and the protecting cylinder unit 19 is made slightly smaller than the thickness size W11 of the drive unit cover 17, as shown in FIG. 2, so that the drive unit cover 17 can be fitted between the supporting cylinder unit 18 and the protecting cylinder unit 19.

As shown in FIG. 2, the opening edge portion 16 of the drive unit cover 17 is provided with the ridge portion 21, which is formed to keep the water-tight state inside of the drive unit cover 17 when the drive unit cover 17 is press-fitted between the supporting cylinder unit 18 and the protecting cylinder unit 19.

As shown in FIG. 2, the ridge portion 21 is formed to extend at a predetermined spacing from the end portion of the drive unit cover 17 on the side of the opening 32 and along the outside of the side edge of the opening edge portion 16. The spacing size W12 between the end portion of the opening 32 and the end edge portion 57 of the ridge portion 21 on the side of the drive unit is made substantially equal to the length size W13 of the protecting cylinder unit 19, as shown in FIG. 4.

Moreover, the thickness size W14 of the drive unit cover 17 at the ridge portion 21, as shown in FIG. 2, is made substantially equal to the spacing size W10 between the supporting cylinder unit 18 and the protecting cylinder unit 19, as shown in FIG. 4.

By fitting the opening edge portion 16 of the drive unit cover 17 between the supporting cylinder unit 18 and the protecting cylinder unit 19, the end edge portion of the ridge portion 21 on the side of the drive unit is arranged at the leading end portion of the protecting cylinder unit 19, and the ridge portion 21 is forced to contact with the inner side face of the protecting cylinder unit 19 so that the inside of the drive unit cover 17 can be protected in the water-tight state so that the water-tight state can be retained at the joint portion between the drive unit cover 17 and the battery box 23.

As shown in FIG. 1 and FIG. 2, the drive unit cover 17 is formed into the generally cylindrical shape for inserting the drive unit 12 thereinto along the length direction of the drive unit cover 17.

The leading end portion of the drive unit cover 17 is formed by closing it in a bag shape so that it can cover and protect the drive unit 12 in the water-tight state when the drive unit 12 is inserted thereinto.

As shown in FIG. 1 and FIG. 2, the leading end shape of the drive unit cover 17 is formed into a generally semicircular shape so that it can give a soft touch to the human body even when the leading end portion of the vibrator 22 is brought into abutment against the human body and vibrated for use.

As shown in FIG. 1 and FIG. 2, the drive unit cover 17 is made of an extensible waterproof material such as a flexible, soft ethylene group elastomer in the embodiment of the invention so that it can be associated for eccentric motions with the shaft 33 of the rotating motor 35, as shown in FIG. 7.

As shown in FIG. 1 and FIG. 2, the drive unit cover 17 is provided outside of its side edge with an auxiliary drive unit cover 53 formed to protrude obliquely.

The auxiliary drive unit cover 53 is formed into a substantially cylindrical shape for inserting the auxiliary vibrating unit 41 thereinto inside of the auxiliary drive unit cover 53 along the length direction of the auxiliary drive unit cover 53.

As shown in FIG. 1 and FIG. 2, the leading end shape of the auxiliary drive unit cover 53 is formed into an elliptical shape so that it can give a soft touch to the human body even when the leading end portion of the auxiliary vibrating unit 41 is brought into abutment against the human body and vibrated for use.

As shown in FIG. 1 and FIG. 3, the power supply unit cover 15 is formed to have the opening 31 at its one end and to cover and protect the power supply unit 11 in the water-tight state outside of the power supply unit 11.

The power supply unit cover 15 is formed into a D-shaped transverse face composed of a cylindrical portion 54 and a flat face portion 55 formed on one side face of the cylindrical portion 54 along the length direction of the cylindrical portion 54.

In the case the power supply unit 11 is covered with the power supply unit cover 15, as shown in FIG. 7, the individual push buttons 24a, 24b, 24c and 24d forming the switch unit 20 are not pushed by the power supply unit cover 15 by arranging the flat face portion 55 on the side of the switch unit 20, so that the switch unit 20 can be protected in the water-tight state.

As shown in FIG. 1 and FIG. 3, the power supply unit cover 15 is made of an extensible waterproof material such as a flexible, soft ethylene group elastomer in the embodiment of the invention. Even in the case, therefore, the individual push buttons 24a, 24b, 24c and 24d are covered with the power supply unit cover 15, as shown in FIG. 7, they can be easily pushed from the outside of the power supply unit cover 15 thereby to perform the driving control of the drive unit 12.

On the other hand, the power supply unit cover 15 is made transparent or semitransparent so that the individual push buttons 24a, 24b, 24c and 24d arranged inside of the power supply unit cover 15 can be viewed from the outside.

Even in the state, therefore, where the power drive unit 12 is covered in the water-tight state with the power supply unit cover 15, the individual push buttons 24a, 24b, 24c and 24d can be easily operated.

As shown in FIG. 3, the power supply unit cover 15 is provided at its opening edge portion 14 with the engaging ridge portion 30, which is formed in a short cylinder shape along the length direction of the power supply unit cover 15.

The engaging ridge portion 30 is provided on its inner side face with a ridge abutting portion 60, which is formed to protrude radially inward along the whole circumference of the inner side face of the engaging ridge portion 30. The ridge abutting portion 60 is formed to protrude in a sectional semicircle shape radially inward on the inner side of the engaging ridge portion 30.

The internal diameter size W7 in the ridge abutting portion 60 on the inner side face of the engaging ridge portion 30 is made to have a smaller diameter size than the internal diameter size W4 of the protecting cylinder unit 19, as shown in FIG. 4.

While the power supply unit 11 is being covered with the power supply unit cover 15, as shown in FIG. 7, the ridge abutting portion 60, which is formed to protrude from the inner side face of the engaging ridge portion 30, comes into abutment against the outer side face of the drive unit cover 17 so that it can hold the water-tight state more reliably between the opening edge portion 14 of the power supply unit 11 and the drive unit cover 17.

With the ridge abutting portion 60 formed on the inner side face of the engaging ridge portion 30, the ridge portion 21 of the drive unit cover 17 covers the protecting cylinder unit 19 press-fitted between itself and the supporting cylinder unit 18, in a more water-tight state from the outside so that the a liquid such as water can be prevented from flowing into the power supply unit 11 thereby to protect the drive device 13 in the water-tight state as a whole.

As shown in FIG. 3, the internal diameter size W15 of the power supply unit cover 15 in the length direction is made substantially equal to the spacing size W16 between the trailing end portion 56 of the power supply unit 11 and the leading end portion 58 of the protecting cylinder unit 19, as shown in FIG. 4.

Therefore, by covering the power supply unit 11 and the leading end portion 58 of the protecting cylinder unit 19 with the power supply unit cover 15, as shown in FIG. 7, the power supply unit 11 and the opening edge portion 16 of the drive unit cover 17 fitted between the supporting cylinder unit 18 and the protecting cylinder unit 19 can be covered, so that the ridge portion 21 of the drive unit cover 17 covers the protecting cylinder unit 19, which is press-fitted between itself and the supporting cylinder unit 18, in a more water-tight state from the outside thereby to protect the engaging portion between the drive unit 12 and the power supply unit 11 in the water-tight state.

As shown in FIG. 3, the power supply unit cover 15 is made of the flexible, soft material. By widening and opening the opening 31 of the power supply unit cover 15 by the hand, therefore, the power supply unit cover 15 can be easily extended to cover the power supply unit 11. When the battery is extracted for exchange from the inside of the battery box 23 of the power supply unit 11, too, the opening 31 of the power supply unit cover 15 can also be widened and opened by the hand so that the power supply unit cover 15 can be easily extended to remove the power supply unit cover 15 from the power supply unit 11.

The switch unit is formed of the push buttons in the embodiment thus far described but may also be formed of a dial formed in a flat circular shape.

In this modification, the dial can be used as a switch for controlling, when turned from the outside of the power supply unit cover 15, the prime mover unit, the motor and so on disposed in the aforementioned drive unit.

Since the power supply unit cover 15 is made of the soft material, the dial can be turned from the outside of the power supply unit cover 15 so that the vibrating unit of the drive unit can be vibrated by the dial thereby to use the drive device as the vibrator having the waterproofing structure.

The switch unit can be configured with a slider, which is made slidable in the length direction of the power supply unit.

In this modification, the slider can be used as a switch for controlling, when slid in the length direction of the power supply unit, the prime mover unit, the motor and so on disposed in the drive unit.

Since the power supply unit cover is made of the soft material, the slider can be slid from the outside of the power supply unit cover so that the vibrating unit of the drive unit can be vibrated by the slider thereby to use the drive device as the vibrator to be used in the water-tight state.

The operation of the waterproofing structure 10 according to the invention is described in detail on the basis of the embodiment shown in the accompanying drawings.

As shown in FIG. 1, the waterproofing structure 10 can be used as one of the vibrator 22 provided with the vibrating unit 36 at its leading end. This waterproofing structure 10 can protect an electronic device such as the prime mover unit constructing the vibrator 22 or the switch unit 20 against the water in the humid environment such as in a bathroom or at a water using area so that the electronic device can be safely used.

As shown in FIG. 1, the waterproofing structure 10 is formed as one for the vibrator 22 acting as the drive device 13 so that it can cover and protect the drive unit 12 and the battery box 23 composing the vibrator 22 in the water-tight state even in the case the vibrator 2 is used in the bathroom or under the humid environment.

As shown in FIG. 5, the rotating motor 35 composing the drive unit 12 is press-fitted in the supporting cylinder unit 18 while being surrounded on its circumferential edge portion by the sponge 48, so that the rotating motor 35 can be fixed in the supporting cylinder unit 18 by the sponge 48.

As shown in FIG. 5, the rotating motor 35 is provided at its drive shaft with the curved shaft 33 extending from the drive shaft, and this shaft 33 is provided at its leading end portion 34 with the vibrating unit 36, which is made of the vibrator 29 disposed at the drive shaft 37 of the prime mover unit 28.

The vibrating unit 36 is protected and fixed by the capsule 45 formed in the elliptical shape.

As shown in FIG. 7, the drive unit 12 is inserted in the drive unit cover 17 along the length direction of the drive unit cover 17, and the capsule 45 constructing the vibrating unit 36 is fixed in abutment against the inward leading end of the drive unit cover 17.

As shown in FIG. 7, the opening edge portion 16 of the drive unit cover 17 is press-fitted along the outer side edge of the supporting cylinder unit 18 so that it is fitted between the supporting cylinder unit 18 and the protecting cylinder unit 19 so that the ridge portion 21 at the opening circumferential edge portion 27 of the drive unit cover 17 can be pressed to contact with the inner side of the protecting cylinder unit 19 thereby to cover and protect the inside of the drive unit cover 17 in the water-tight state.

As shown in FIG. 7, in the case the vibrator 22 is used in the bathroom or under the humid environment, it can be used in the water-tight state by arranging the power supply unit 11 inside of the power supply unit cover 15.

In the case the power supply unit cover 15 is made to cover the power supply unit 11, its opening portion 31 is extended to enlarge the internal diameter size W7 of the engaging ridge portion 30 formed at the opening 31 so that the external diameter size W6 of the power supply unit 11 is made larger than the outer diameter size W6 of the power supply unit 11 and the external diameter size W17 of the protecting cylinder unit 19, as shown in FIG. 4. Therefore, the power supply unit 11 and the protecting cylinder unit 19 can be inserted into the opening 31 thereby to arrange the power supply unit 11 in the power supply unit cover 15.

The engaging ridge portion 30 is shrunken by releasing its extension while the power supply unit 11 and the protecting cylinder unit 19 are being arranged in the power supply unit cover 15.

As the result of the shrinkage of the engaging ridge portion 30, as shown in FIG. 7, the internal diameter size W7 of the ridge abutting portion 60 disposed on the inner side face of the engaging ridge portion 30 is shrunken to a smaller diameter size than the outer diameter size W6 of the power supply unit 11 and the outer diameter size W17 of the protecting cylinder unit 19. While the power supply unit 11 and the protecting cylinder unit 19 are being arranged in the opening 31, the ridge abutting portion 60 comes into the opening circumferential edge portion 27 of the drive unit cover 17 so that the inside of the power supply unit cover 15 can be protected in the water-tight state.

By the ridge abutting portion 60 formed on the inner side face of the engaging ridge portion 30, the ridge portion 21 of the drive unit cover 17 further covers the protecting cylinder unit 19 press-fitted between itself and the supporting cylinder unit 18, in the water-tight state from the outside so that a liquid such as water can be prevented from flowing into the power supply unit 11 thereby to protect the drive device 13 as a whole in the water-tight state.

In this case, the internal diameter size W7 of the ridge abutting portion 60 formed on the inner side face of the engaging ridge portion 30 is shrunken to a smaller diameter size than the external diameter size W17 of the protecting cylinder unit 19. Even in the case the engaging ridge portion 30 is curled up more or less, it does not come out from the protecting cylinder unit 19 so that it can protect the power supply unit 11 in the water-tight state.

In the case the battery in the battery box 23 is to be exchanged, as shown in FIG. 6, the opening 31 of the power supply unit cover 15 is extended, as shown in FIG. 7, so that the internal diameter size W7 of the engaging ridge portion 30 formed at the opening 31 is made larger than the external diameter size W6 of the power supply unit 11 and the external diameter size W17 of the protecting cylinder unit 19, as shown in FIG. 4. As a result, the protecting cylinder unit 19 and the power supply unit 11 can be extracted from the opening 31.

Next, the cover portion 50 on the side face of the battery box 23 is slid along the length direction of the battery body 23, as shown in FIG. 6, the battery case 49 can be exposed, and the battery held by the battery holding springs 52 can be extracted for the exchange.

In the case the drive unit 12 is activated and used as the vibrator 22, the individual push buttons 24a, 24b, 24c and 24d composing the switch unit 20, which are disposed inside of the power supply unit cover 15, are controlled from the outside of the power supply unit cover 15, as shown in FIG. 7, so that the vibrator 22 can be driven.

Since the power supply unit cover 15 is made of the soft material, the individual push buttons 24a, 24b, 24c and 24d can be pushed from the outside of the power supply unit cover 15. Since, the power supply unit cover 15 is made of the semitransparent material, the positions of the individual push buttons 24a, 24b, 24c and 24d can be visually confirmed through the power supply unit cover 15 covering the power supply unit 11.

As a result, the user can push the individual push buttons 24a, 24b, 24c and 24d, although they are covered with the power supply unit cover 15, to use the vibrator in the water-tight state.

Specifically, when the push button 24a is pushed from the outside of the power supply unit cover 15, the drive shafts of the rotating motor 35 and the prime mover unit 28 are rotated, as shown in FIG. 5.

When the rotating motor 35 rotates, the curved shaft 33 extending from the drive shaft of the rotating motor 35 rotates so that the capsule 45 disposed at the leading end portion of the shaft 33 makes the eccentric motions on the drive shaft of the rotating motor 35, as shown in FIG. 7.

Since the capsule 45 is fixed in abutment against the inward leading end of the drive unit cover 17, the drive unit cover 17 having the flexibility also makes eccentric motions on the drive shaft of the rotating motor in according to the eccentric motions of the capsule 45.

As the drive shaft 37 of the prime mover unit 28 rotates, the vibrator 29 on the drive shaft 37 is rotated to vibrate the capsule 45.

Since the capsule 45 is fixed in abutment against the inward leading end of the drive unit cover 17, it can be used as the vibrator capable of vibrating the leading end portion of the drive unit cover 17.

When push button 24b is pushed from the outside of the power supply unit cover 15, the rotating speed of the drive shafts of the rotating motor 35 and the prime mover unit 28 can be raised to a high speed.

As a result, the speed of the eccentric motions of the drive unit cover 17 and the vibrating speed at the leading end portion of the drive unit cover 17 can be raised to provide a more exciting vibrator 22.

When the push button 24c is pushed from the outside of the power supply unit cover 15, the drive shaft 43 of the auxiliary prime mover unit 42 rotates, as shown in FIG. 5.

When the drive shaft 43 of the auxiliary prime mover unit 42 rotates, the vibrator 44 on the drive shaft 43 is rotated to vibrate the auxiliary capsule 46.

Since the auxiliary capsule 46 is fixed in abutment against the inward leading end of the auxiliary drive unit cover 53, as shown in FIG. 1, it can be used as the vibrator capable of vibrating the leading end portion of the auxiliary drive unit cover 53.

When the push button 24d is pushed from the outside of the power supply unit cover 15, the rotating speed of the drive shaft 43 of the auxiliary prime mover unit 42 can be raised to a high speed.

As a result, the vibrating speed of the leading end portion of the auxiliary drive unit cover 53 can be raised to provide a more exciting vibrator 22.

1. A waterproofing structure for a drive device including: a power supply unit; and a drive unit formed to protrude from one end of said power supply unit and to be activated with an electric power supplied from said power supply unit, comprising:
a power supply unit cover formed to have an opening at its one end and to cover said power supply unit in a water-tight state; and
a drive unit cover formed to have an opening at its one end and to cover said drive unit in a water-tight state,
wherein said power supply unit includes at its one end:
a supporting cylinder unit formed to protrude to the side of said drive unit; and
a protecting cylinder unit formed outside of the diameter of and at a predetermined spacing size from said supporting cylinder unit, and
wherein said drive unit cover has its opening edge portion fitted in a water-tight state between said supporting cylinder unit and said protecting cylinder unit so that the opening circumferential edge portion of said drive unit cover and said protecting cylinder unit in a water-tight state with the opening edge portion of said power supply unit cover.

2. A waterproofing structure according to claim 1,
wherein the opening edge portion of said drive unit cover has a ridge portion formed along the outside of the side edge of said opening edge portion for holding the water-tight state inside of said drive unit cover when press-fitted between said supporting cylinder unit and said protecting cylinder unit.

3. A waterproofing structure according to claim 2,
wherein said drive unit cover is made of a waterproof material having an extensibility and has an internal diameter size substantially equal to the external diameter size of said supporting cylinder unit, and
wherein said ridge portion has an external diameter size substantially equal to the internal diameter size of said protecting cylinder unit.

4. A waterproofing structure according to claim 2,
wherein said power supply unit cover is made of a waterproof material having an extensibility and has an internal diameter size slightly larger than the external diameter size of said power supply unit, and
wherein the opening edge portion of said power supply unit cover has an engaging ridge portion formed smaller than the internal diameter size of said protecting cylinder unit.

5. A waterproofing structure according to claim 1,
wherein said power supply unit cover is made of a soft material and disposed at said power supply unit for operating a switch unit disposed to control said drive unit.

6. A waterproofing structure according to claim 1,
wherein said power supply unit is formed of a battery box, and
wherein said power supply unit cover can be removed, if necessary.

7. A waterproofing structure according to claim 3,
wherein said drive unit includes a prime mover, and a vibrator formed to vibrate in association with said prime mover, and
wherein said switch unit is configured with push buttons.

8. A waterproofing structure according to claim 5,
wherein said switch unit is configured with a dial.

9. A waterproofing structure according to claim 5,
wherein said switch unit is configured with a slider.
